(19) United States
(12) Patent Application Publication
(10) Pub. No.: US 2012/0278090 A1
(43) Pub. Date: Nov. 1, 2012

(54) SYSTEMS AND METHODS FOR MANAGING HOSPITALITY FACILITIES

(76) Inventors: Daniel R. Frankfort, Chicago, IL (US); Fernando J. Rosario, Pembroke Pines, FL (US); Jacqueline Bonnet, Miami, FL (US); Malcolm A. McNamara, Alexandria, VA (US)

(21) Appl. No.: 13/096,482

(22) Filed: Apr. 28, 2011

(51) Int. Cl. G06Q 10/00

(52) U.S. Cl. 705/1.1

(57) ABSTRACT

Systems and methods are provided for managing a plurality of hospitality facilities. A property management component and an external component are located remotely from the plurality of hospitality facilities. The property management component is integrated with the external component to provide hospitality services at the plurality of hospitality facilities. The external component includes a loyalty component that interacts with the integrated system for providing a user with access to the hospitality services e.g., purchasing, at one of the plurality of hospitality facilities.

### TECHNICAL FIELD

This disclosure is directed to systems and methods for managing hospitality facilities, and more particularly, to systems and methods for managing a plurality of hospitality facilities with a centralized system.

### BACKGROUND

Lodging companies typically invest in upgrading their properties and customer service, and developing and extending their brands to serve a wider variety of consumer segments. These lodging companies typically employ expensive, outdated and often inflexible legacy property management systems (“PMS”) in managing their properties and providing customer services. In addition, these legacy systems are typically located on the properties of the lodging companies, such that it may be necessary to perform any maintenance or upgrade physically on the properties. Further, a typical legacy PMS may be operated as a separate system from one or more of the lodging company's central reservation system, customer royalty/loyalty management system, property service management system, and/or financial service system.

It is desirable to provide systems and methods to address these inefficiencies in the legacy property management systems.

### SUMMARY

In one embodiment, a method is provided for managing a plurality of hospitality facilities. The method may include providing a property management component located remotely from the plurality of hospitality facilities. The method may also include providing an external component located remotely from the plurality of hospitality facilities. The method may further include integrating the property management component with the external component via an integration layer to provide an integrated system. The integrated system may provide hospitality services at the plurality of hospitality facilities. Moreover, the method may include providing an interface for accessing the integrated system. The interface may be located on one of the plurality of hospitality facilities. Furthermore, the external component may include a loyalty component that interacts with the integrated system for providing a user with the ability to access hospitality services, including purchasing, at one of the plurality of hospitality facilities.

In another embodiment, a system is provided for managing a plurality of hospitality facilities. The system may include a property management component located remotely from the plurality of hospitality facilities. The system may also include an external component located remotely from the plurality of hospitality facilities. The system may further include an integration layer integrating the external component and the property management component to provide services at the plurality of hospitality facilities. Moreover, the system may include an interface for accessing the system. The interface may be located on one of the plurality of hospitality facilities. Furthermore, the external component may include a loyalty component that interacts with the integrated system for providing a user with the ability to access services, including purchasing, at one of the plurality of hospitality facilities.

In yet another embodiment, a system for managing a plurality of hospitality facilities is provided. The system may include a property management component located remotely from the plurality of hospitality facilities. The system may also include an external enterprise component located remotely from the plurality of hospitality facilities. The system may further include a property specific system located remotely from the plurality of hospitality facilities. Moreover, the system may include an integration layer. The integration layer may integrate the external component and the property specific system with the property management component to provide services at the plurality of hospitality facilities. The system may also include an interface for accessing the system. The interface may be located on one of the plurality of hospitality facilities. Furthermore, the external component may include a loyalty component that interacts with the integrated system for providing a user with the ability to access services, including purchasing, at one of the plurality of hospitality facilities.

It is to be understood that both the foregoing description and the following description are exemplary and explanatory only and are not restrictive of the invention, as claimed.

The accompanying drawings, which are incorporated in and constitute a part of this specification, illustrate exemplary embodiments of the invention and together with the description, serve to explain the principles of the invention.

### BRIEF DESCRIPTION OF THE DRAWINGS

FIG. 1 is a block diagram illustrating an exemplary embodiment of a system for managing a plurality of hospitality facilities;

FIG. 2 illustrates an exemplary embodiment of an administration and configuration layer that may be a component of the system of FIG. 1;

FIG. 3 illustrates an exemplary embodiment of an application layer that may be a component of the system of FIG. 1;

FIG. 4 illustrates an exemplary embodiment of an infrastructure layer that may be a component of the system of FIG. 1;

FIG. 5 illustrates an exemplary embodiment of a data access and integration layer that may be a component of the system of FIG. 1;

FIG. 6 illustrates an exemplary embodiment of a third party integration layer that may be a component of the system of FIG. 1;

FIG. 7 illustrates an exemplary embodiment of an external enterprise system and a property specific system that may be components of the system of FIG. 1; and

FIG. 8 illustrates an exemplary process for managing a plurality of hospitality facilities.

### DETAILED DESCRIPTION

Reference will now be made in detail to the present exemplary embodiments consistent with the invention, examples of which are illustrated in the accompanying drawings. Wherever convenient, the same reference numbers will be used throughout the drawings to refer to the same or like parts.

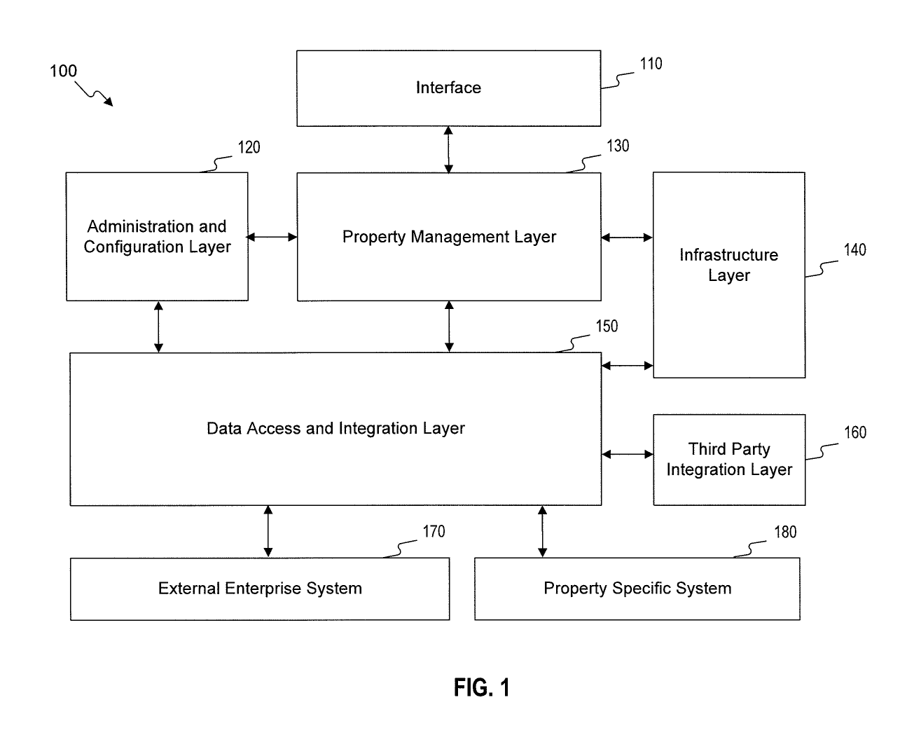

FIG. 1 illustrates an exemplary system 100 that may be utilized in managing a plurality of hospitality facilities. System 100 may include an interface 110, an administration and configuration layer 120, a property management layer 130, an infrastructure layer 140, a data access and integration layer 150, a third party integration layer 160, an external enterprise system 170, and a property specific system 180. It is contemplated that system 100 may include more or less components, if appropriate and/or necessary. In some embodiments, one or more components of system 100 may be centrally managed and hosted while client corporations may access system 100 via interface 110. Centrally managing and hosting the components of system 100 may help to reduce costs in maintaining individual systems 100, and may also help to facilitate uniform upgrade of system 100. In addition, centrally managing and hosting the components of system 100 may allow multiple client corporations to utilize system 100 at the same time.

In some embodiments, interface 110 may be a web interface. Users of interface 110 may be able to view and access different functionalities of interface 110 depending on level of security and/or authorization associated with the users. Interface 110 may also include graphics unique to a given brand, such as Residence Inn®, JW Marriott, etc. In some embodiments, interface 110 may include the ability to display texts and/or graphic in different languages based on geography and/or local market preferences. Users of interface 110 may select the language that interface 110 displays. Interface 110 may also be customized for a particular property (e.g., hospitality facility), for a particular geography, or a particular brand, based on user profiles and/or business rules that may be predetermined, i.e., language preference, up-sell and/or forced sell of products, etc.

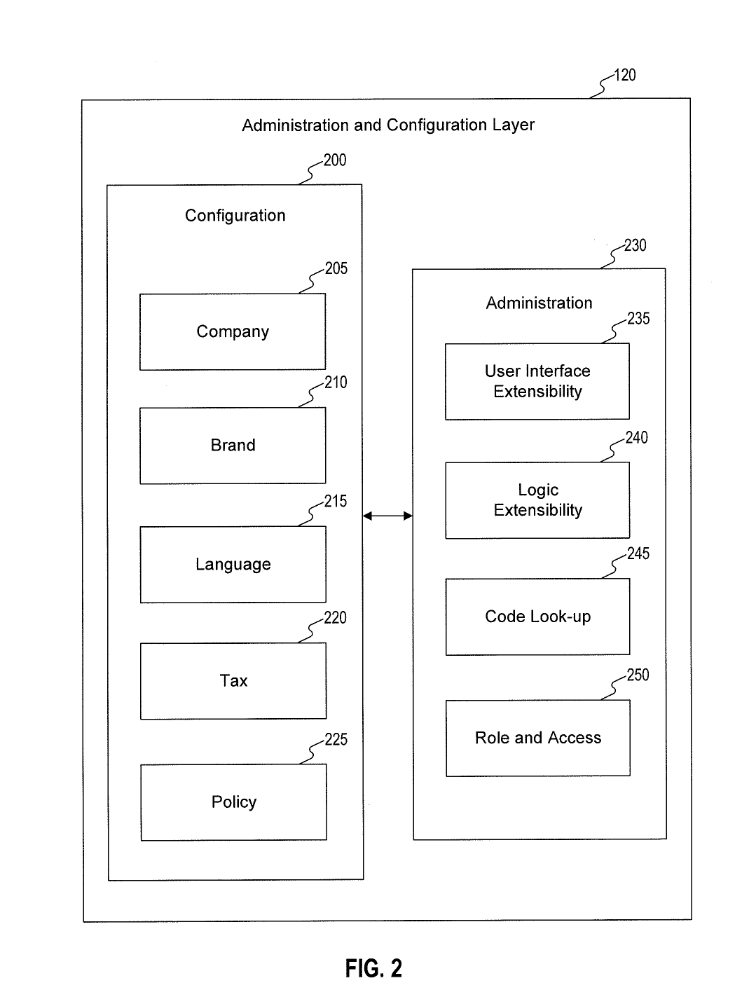

As shown in FIG. 2, administration and configuration layer 120 may include a configuration component 200 and an administration component 230. In the embodiment as shown, configuration component 200 may include a company information component 205, a brand information component 210, a language component 215, a tax component 220 and a policy component 225. In some embodiments, company information component 205 may include information relating to a company, such that interface 110 may be configured according to the information relating to the company. In some embodiments, brand information component 210 may include information relating to a brand, such that interface 110 may be configured according to the information relating to the brand. In some embodiments, language component 215 may include different languages that may be displayed on interface 110. According to some embodiments, company information component 205, brand information component 210, and language component 215 may help to provide configuration flexibility for a company to make global system changes impacting the look and feel of interface 110 based on developments occurring at the company, branding initiatives, and/or language preferences.

In some embodiments, tax component 220 may help to provide a user of system 100 the ability to configure tax policies by a particular property (e.g., hospitality facility) based on local and/or federal law. In some embodiments, policy component 225 may help to enable creation and enforcement of global policy from a corporate entity governing a suite of hospitality operations. Similarly, policy component 225 may also help to enable creation and enforcement of local policy which may in turn enable flexibility for unique business needs for a particular location at the property operations level, for example. It is contemplated that one or more of the various components of configuration component 200 may be combined into a single component. For example, company information component 205, brand information component 210, and language component 215 may be combined into a single component. It is also contemplated that any of the various components of configuration component 200 may be separated into one or more components. For example, policy component 225 may be separated into a global policy component and a local policy component.

In the embodiment as shown in FIG. 2, administration component 230 may include a user interface extensibility component 235, a logic extensibility component 240, a code look-up component 245, and a role and access component 250. In some embodiments, user interface extensibility component 235 may help to allow interface 110 to be configured according to information provided by company information component 205, brand information component 210, or according to location of a property (e.g., hospitality facility). In some embodiments, logic extensibility component 240 may allow a user of system 100 to use common code base to support different business requirements. Logic extensibility component 240 may address difficulties resulting from changes in data requirements and business validations based on location of property and/or brand. In some embodiments, logic extensibility component 240 may help to provide a user of system 100 the ability to configure additional data elements and to place these data elements on a configurable container within a user interface, such as interface 110.

In some embodiments, code look-up component 245 may help to localize data to provide support for local policies and data extensions configured within logic extensibility component 240. In some embodiments, code look-up component 245 may include defined extended files for code table and/or relationships between different codes (e.g., parent-child relationship). In some embodiments, role and access component 250 may include definitions for global and/or local roles of users that may help to control access to application functions and/or data for efficient allocation of resources. It is contemplated that users of system 100 may create user profiles identifying user specific preferences such that configuration component 200 and/or administration component 230 may help to configure interface 110 according to the user's preferences.

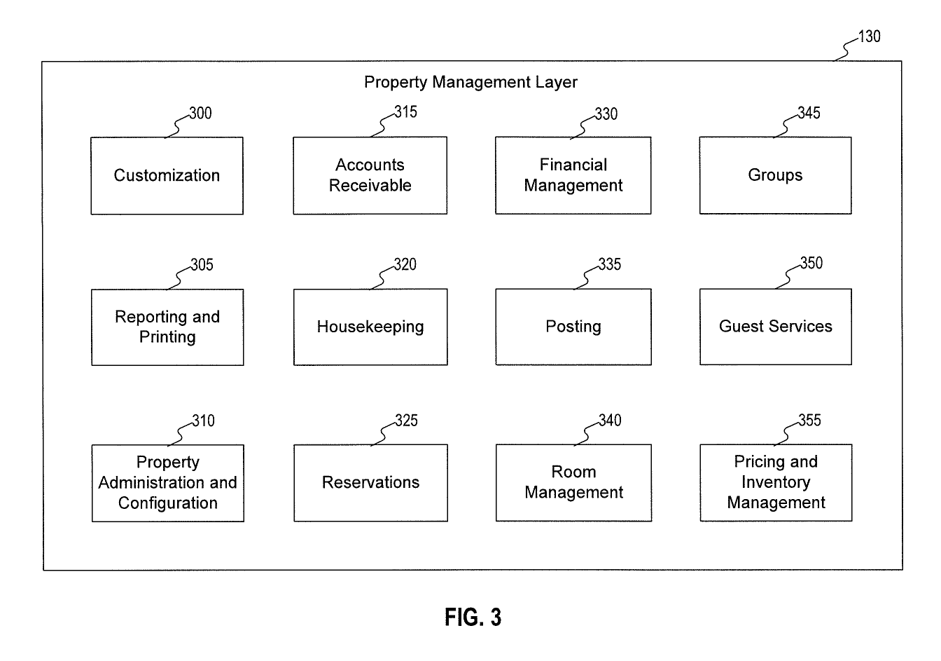

As shown in FIG. 3, property management layer 130 may include may include a customization component 300, a reporting and printing component 305, a property administration and configuration component 310, an accounts receivable component 315, a housekeeping component 320, a reservations component 325, a financial management component 330, a posting component 335, a room management component 340, a groups component 345, a guest services component 350, and a pricing and inventory management component 355. It is contemplated that one or more components of property management layer 130 may be an application or a module that is able to run on a data processing or computing system (not shown). It is also contemplated that property management layer 130 may include applications and/or modules capable of performing the common functionalities that a typical PMS performs.

In some embodiments, customization component 300 may help to provide a corporation the ability to customize one or more of the components of property management layer 130 to fit strategic and/or unique business demands of the corporation. For example, customization component 300 may include one or more modified components of property management layer 130. Customization component 300 may similarly include one or more components that are typically not included in property management layer 130. Users of system 100 may configure customization component 300 to fit the strategic and/or business demands of the corporation. In one embodiment, customization component 300 may be configured to create a bundled package that includes one or more hotel products that can be provided at individual properties. For example, a bundled package may be a dinner package that includes one or more tickets to a show, dinner for one or more guests at a restaurant, and transportation services provided to and from the show, the restaurant, and the individual property where the guests are staying. Bundled packages may be created, modified, and/or deleted either remotely or locally (i.e., by a user accessing system 100 on a specific property). It is contemplated that in addition to including one or more hotel products in a bundled package, a user may specify a name associated with the bundled package, an inventory information associated with the bundled package, an expiration time associated with the bundled package, a cost associated with the bundled package, etc. It is further contemplated that a bundled package may be created, modified, and/or deleted partially remotely and partially locally. For example, in the dinner package example discussed above, the transportation services may be created remotely, while the rest of the dinner package may be created locally.

In some embodiments, reporting and printing component 305 may help to provide users of system 100 the ability to aggregate, process, and/or generate reports relating to an individual property's data elements and/or print these data elements to individual printer devices located on the property in a variety of formats. In some embodiments, property administration and configuration component 310 may help to provide users of system 100 the ability to configure certain aspects of system 100 for individual property (hospitality facility) locations. For example, a user of system 100 may utilize property administration and configuration component 310 to configure certain tax policies, up-selling, and/r rate offerings, etc. for any specific property.

In some embodiments, accounts receivable component 315 may help to provide users of system 100 the ability to aggregate, process, and/or generate reports relating to an individual property's receivable accounts. Accounts receivable component 315 may also include appropriate rule set for processing the accounts and/or generating the reports. In some embodiments, housekeeping component 320 may assist in the processing of room upkeep and readiness throughout a day of operation of individual properties. In some embodiments, reservations component 325 may help to provide users of system 100 the ability to book and/or manage future reservations/stays for individual properties.

In some embodiments, financial management component 330 may help to provide users of system 100 the ability to aggregate, process, and/or generate reports relating an individual property's financial transactions. Financial management component 330 may also include appropriate rule set for processing the accounts and/or generating the reports. In some embodiments, posting component 335 may help to provide users of system 100 the ability to aggregate, process, and/or generate reports relating an individual property's room allotments, timing of checkouts. Posting component 335 may also help to process and/or generate appropriate stay-folios and general ledger communication for revenue recognition. In some embodiments, room management component 340 may help to provide users of system 100 the ability to aggregate, process, and/or generate reports relating an individual property's physical inventory, i.e., availability of certain room and/or room type, readiness of certain room for guest arrival, check out clearing, etc.

In some embodiments, groups component 345 may help to provide users of system 100 the ability to book, manage, and financially process group reservations. For example, in many instances, a group reservation receive a lower property rate as compared to an individual reservation. Groups component 345 may include appropriate rule sets to determine the appropriate property rates for group reservations. It is contemplated that groups component 345 may include the ability to assign certain types of rooms in a individual property based on the size of the group. In some embodiments, guest services component 350 may provide concierge-like functions to accommodate special guest interaction. For example, users of system 100 may utilize guest services component 350 to provide guests at individual properties with solutions to their questions, providing recommendations to local attractions, making reservations for restaurants, spas, shows and special events, arranging transportation or providing directions to various destinations, etc.

In some embodiments, pricing and inventory management component 355 may help to provide users of system 100 the ability to associate individual room rates/pricing along with management of the inventory available. It is contemplated that one or more components of property management layer 130 may transmit and receive data and information from each other. For example, room management component 340 may transmit data and information relating to relating an individual property's physical inventory to pricing and inventory management component 355. pricing and inventory management component 355 may in turn associate the individual room rates/pricing with the available inventory.

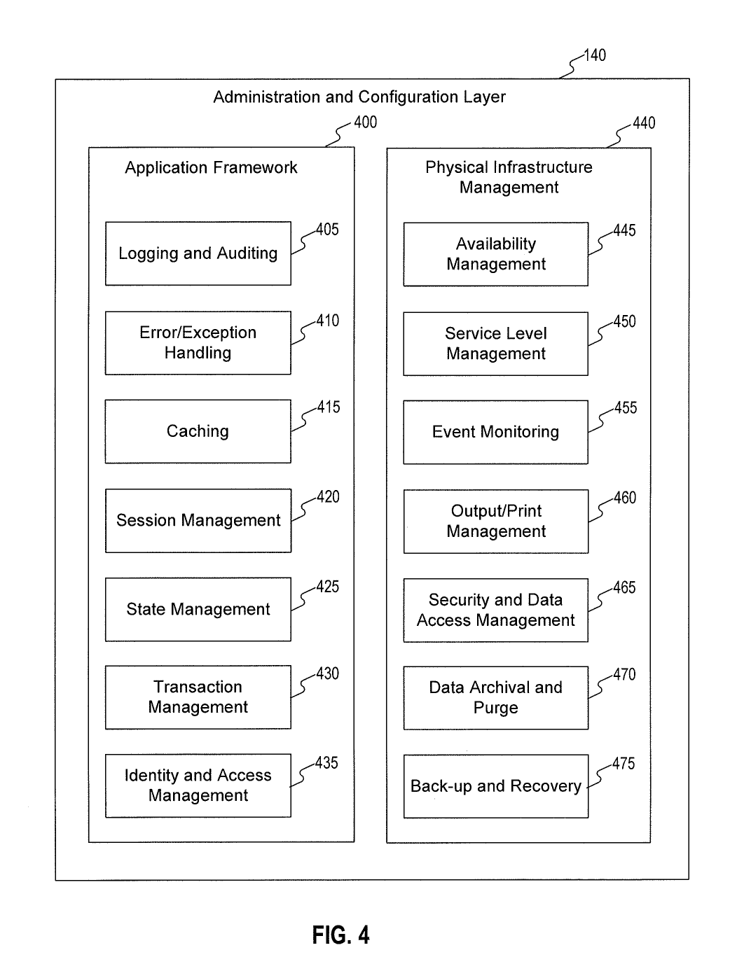

As shown in FIG. 4, infrastructure layer 140 may include an application framework component 400 and a physical infrastructure management component 440. In some embodiments, application framework component 400 may include a logging and auditing component 405, an error/exception handling component 410, a caching component 415, a session management component 420, a state management component 425, a transaction management component 430, and an identify and access management component 435. In some embodiments, logging and auditing component 405 may provide the framework for logging application messages and errors with the ability to audit specific messages or aspects of a message. In some embodiments, error/exception handling component 410 may provide standardized methods for handling errors and exceptions. These standardized methods may be preset by users of system 100, for example. These standardized methods may also be set by clients, such as hospitality facility chains.

In some embodiments, caching component 415 may provide a framework for caching data, such as state, data for workflow work items, etc. In some embodiments, session management component 420 may provide a framework for keeping information about a user's session of using system 100. In some embodiments, state management component 425 may provide a framework for storing the state of the “objects” within the system, such as a task, a work item, a document, customer profile, etc. In some embodiments, transaction management component 430 may provide a framework for maintaining the integrity of transactions which occur in system 100. It is contemplated that the various components of application framework component 400 may be responsible for setting the boundaries associated with any transactions which occur in system 100. It is also contemplated that transaction management component 430 may be responsible for managing the integrity of the transaction across the various components of application framework component 400. In some embodiments, identify and access management component 435 may help to ensure role based authentication and authorization to control access to the various components of application framework component 400 and to control access to data associated with the various components. It is contemplated that identify and access management component 435 may enable a customizable role configuration with respect to naming and privilege association. For example, users of system 100 and/or client corporations may provide appropriate rule set for naming schemes, and privileges associated with different user roles within system 100.

In the embodiment as shown in FIG. 4, physical infrastructure management component 440 may include an availability management component 445, a service level management component 450, an event monitoring component 455, an output/print management component 460, a security and data access management component 465, a data archival and purge component 470, and a back-up and recovery component 475. In some embodiments, availability management component 445 may manage overall availability of various components of system 100 and providing supporting nodes of operation of these components. In some embodiments, service level management component 450 may include monitoring tools that may monitor the system to ensure stability and performance of targeted services levels. These targeted services may be set by users of system 100 and/or by client corporations, for example.

In some embodiments, event monitoring component 455 may include application and infrastructure introspection monitoring for specific events occurring within system 100. Event monitoring component 455 may help to ensure overall stability, performance, and/or security of system 100, for example. In some embodiments, output/print management component 460 may manage the printers used by users of system 100 to print documents. These printers may be located at a centralized location, or these printers may be located at individual hospitality facilities, for example. In some embodiments, output/print management component 460 may manage file servers used by users of system 100 to store documents and information. It is contemplated that one or more of the file servers may be located at a centralized location. It is also contemplated that one or more of the file servers may be located at individual hospitality facilities.

In some embodiments, security and data access management 465 may include accurate identification and access rules for users requesting access to the various components within application framework component 400 or other infrastructure assets. Security and data access management 465 may assist in management of user identifications and passwords, for example. In some embodiments, data archival and purge component 470 may help to provide users of system 100 the ability to archive and/or purge data based on business and regulatory compliance. It is contemplated that users may set different archive and/or purge rules to be carried out by data archival and purge component 470. In some embodiments, back-up and recovery component 475 may assist in backing-up and recovery of systems and data. It is contemplated that back-up and recovery may be performed automatically by system 100. It is also contemplated that a user may manually activate back-up and recovery component 475 to perform backing-up and recovery of systems and data.

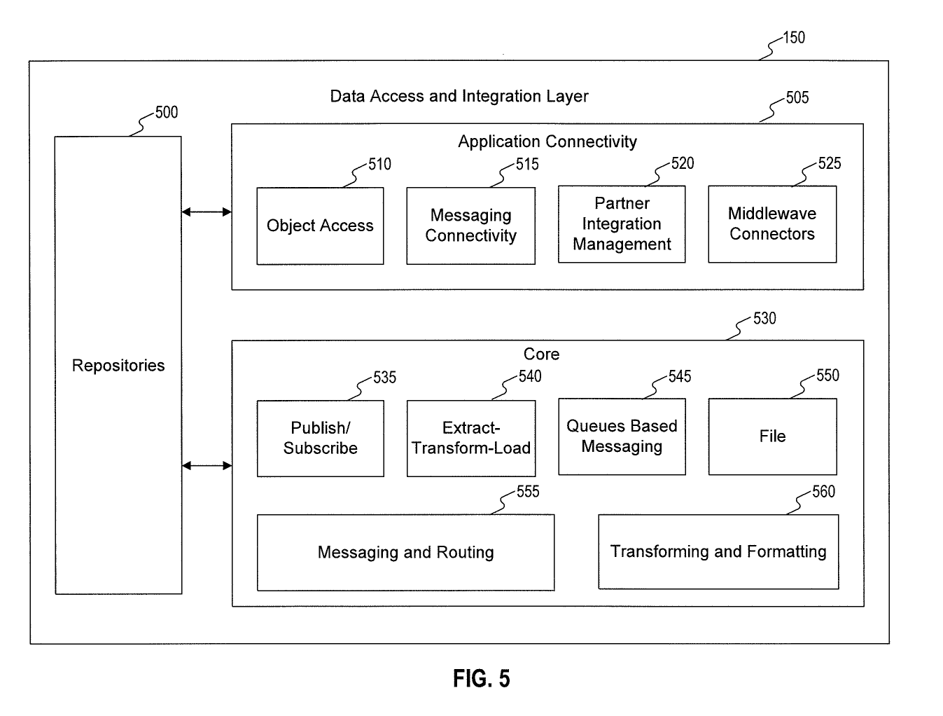

As shown in FIG. 5, data access and integration layer 150 may include repositories 500, an application connectivity section 505, and a core section 530. It is contemplated that integration layer 150 may receive and/or transmit data from external (and/or third party) systems. The data may be in different format and it is contemplated that integration layer 150 include components for translating the different format in order to process the data. In some embodiments, repository 500 may store data and information generated and transmitted between the various components of system 100. For example, repositories 500 may include data and information generated and transmitted between interface 110, administration and configuration layer 120, property management layer 130, infrastructure layer 140, data access and integration layer 150, third party integration layer 160, external enterprise system 170, and property specific system 180. In some embodiments, repositories 500 may include a plurality of repositories with each of the plurality of repositories being dedicated to one of the various components of system 100. For example, a repository may include data and information from interface 110 and a separate repository may include data and information from administration and configuration layer 120. In some embodiments, repositories 500 may include separate repositories for storing transactional data of system 100 and for storing reporting data of system 100 that can help to limit performance impacts related to report generation. It is contemplated that repositories 500 may consist of a single repository.

In some embodiments, application connectivity section 505 may include an object access component 510, a messaging connectivity component 515, a partner integration management component 520, and middleware connectors 525. In some embodiments, object access component 510 may help to provide users of system 100 the ability to access objects and components that may be internal to system 100 or another system via object-based protocols. Object access component 510 may help to provide the gateway in and out of applications (components) of system 100, for example. In some embodiments, messaging connectivity component 515 may help to provide connectivity and transport between applications across multiple protocols. In some embodiments, partner integration management component 520 may help to provide the ability to configure and manage connections to business partners. Partner integration management component 520 may facilitate interaction between external systems from other business partners and system 100. In some embodiments, middleware connectors 525 may help to facilitate the integration of heterogeneous systems by acting as a point for interconnections to and from the common messaging infrastructure.

In some embodiments, core section 530 may include a publish/subscribe component 535, an extract-transform-load component 540, a queues based messaging component 545, a file transfer component 550, a messaging and routing component 555, and a transforming and formatting component 560. In some embodiments, publish/subscribe component 535 may receive a subset of a total message published along with filtering capabilities. In some embodiments, publish/subscribe component 535 may publish a topic and/or messages for consumption by clients. The filtering capabilities may include topic-based filtering and content-based filtering, for example. With respect to topic-based filtering, messages may be published to topics or defined logical channels a user may subscribe or broadcast to for specific data a client of the user may provide or consume that is related to system 100. With respect to content-based filtering, messages may be delivered to a subscriber, i.e., a user of system 100 or a client of the user. if the attributes of those messages match constraints defined by the subscriber. In other words, messages that do not match constraints defined by the subscriber may not be delivered to the subscriber.

In some embodiments, extract-transform-load component 540 may include capabilities to enable data movement between various data stores, such as those included in repositories 500. In some embodiments, queues based messaging component 545 may help to create and manage a queue to serve as a temporary storage location from which messages can be sent when certain conditions are met. These conditions may be set by users of system 100, may be predetermined, or may be set by clients. In some embodiments, queues based messaging component 545 may help to enable communication across heterogeneous networks and between computers that are (or are not) connected. In some embodiments, file transfer component 550 may help to transfer data files between systems using utilities, such as FTP (File Transfer Protocol), NDM (Network Data Mover), or any appropriate file transfer methods.

In some embodiments, messaging and routing component 555 may help to ensure that a sender delivers a message to a receiver once without repeated delivery. It is contemplated that messaging and routing component 555 may attempt delivery of a message more than once if it is determined that the message was not received properly by the receiver. In some embodiments, messaging and routing component 555 may help to route messages to appropriate service providers based on appropriate rule set that may be set by users of system 100. In some embodiments, messaging and routing component 555 may help to match a message response to the originating request over an asynchronous or synchronous channel. In some embodiments, messaging and routing component 555 may help to reconstruct the proper message sequence for messages that are delivered asynchronously or synchronously across one or more channels. It is contemplated that messaging and routing component 555 may include one or more subcomponent that can perform the various functions.

In some embodiments, transforming and formatting component 560 may help to map and/or translate discrete data from a source data (and/or message structure) to a target data (and/or message structure). In some embodiments, transforming and formatting component 560 may help to repackage messages from one messaging protocol to another. In some embodiments, transforming and formatting component 560 may assist in tunneling a message through an non-native messaging infrastructure. It is contemplated that any appropriate tunneling protocols may be used by transforming and formatting component 560. In some embodiments, transforming and formatting component 560 may help to construct objects or other types of data representation from a message stream. It is contemplated that transforming and formatting component 560 may include one or more subcomponents that can perform the various functions.

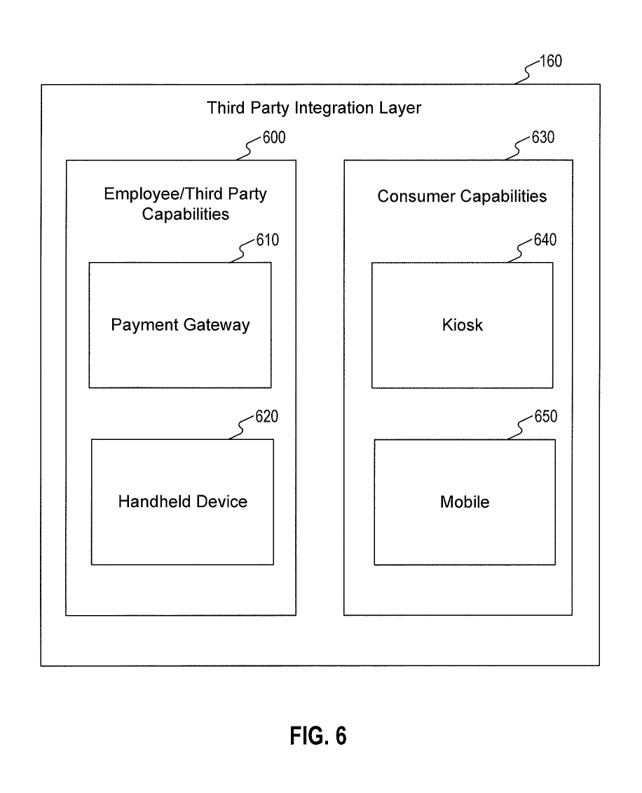

As shown in FIG. 6, third party integration layer 160 may include an employee/third party capabilities section 600 and a consumer capabilities section 630. In some embodiments, employee/third party capabilities section 600 may include a payment gateway 610 and a handheld device component 620. In some embodiments, payment gateway 610 may help to provide connectivity, messaging, and repeated attempt mechanisms to interfaces with various payment gateways related to a property's payment operations. In some embodiments, handheld device component 620 may help to provide common user interface functions to users via industry standard devices such as a handheld device. In some embodiments, consumer capabilities section 630 may include a kiosk 640 and a mobile component 650. In some embodiment, similar to handheld device 620, kiosk 640 may help to provide common user interface functions to users. In some embodiments, mobile component 650 may help to enable users to access system 100 via mobile devices, such as cellular phones, PDAs, laptops, etc.

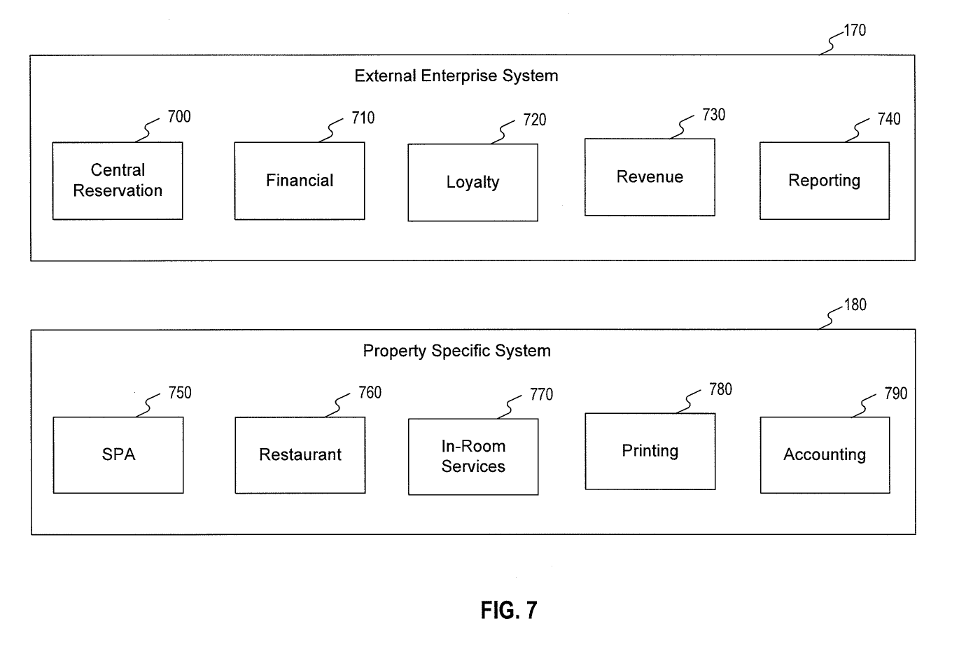

As shown in FIG. 7, external enterprise system 170 may include a central reservation component 700, a financial component 710, a loyalty component 720, a revenue component 730, and a reporting component 740. In some embodiments, central reservation component 700 may contain and manage all property inventory at a global level, i.e., across an entire hospitality facilities chain. In some embodiments, central reservation component 700 may interact with various sales channels to inquire, request, and/or allocate inventory (i.e., rooms, packages, etc.). In some embodiments, financial component 710 may help to manage the financial transactions at a global level. These financial transactions may be integrated to a central general ledger for tax and/or auditing purposes, or for an overall profitability analysis, for example. In some embodiments, financial component 710 may also help to manage the financial transactions at individual properties.

In some embodiments, loyalty component 720 may store information for participants in a lodging company's loyalty program. Loyalty component 720 may help to track and manage the participants' preferences, historic stays, and future reservations, for example. In some embodiments, loyalty component 720 may interact with reservations component 325 and/or property specific system 180 and reward points as a monetary equivalent in many cases providing the participants purchasing ability for rooms, on-property amenities and/or services, and others guest services. It is contemplated that loyalty component 720 may interact with reservations component 325 and/or property specific system 180 manually. For example, when a participant wishes to utilize loyalty points for accessing any guest services or for payment of the room, a user of system 100 may manually access system 100 to determine the appropriate amount due for the participant. It is also contemplated that loyalty component 720 may automatically interact with reservations component 325 and/or property specific system 180. For example, a participant's stay and/or his purchasing of any guest services may be automatically deducted from the amount due by utilizing his reward points. It is further contemplated that the interaction of loyalty component 720 with reservations component 325 and/or property specific system 180 may be set up by users of system 100 such that the interaction may be partially automatic. For example, a user may set up loyalty component 720 to automatically apply a participant's loyalty points with respect to payment of the room, but not with respect to payment for guest services.

In some embodiments, revenue component 730 may help to provide users of system 100 the ability to process and determine revenue associated with individual hospitality facilities. In some embodiments, revenue component 730 may process and determine revenue at a global level, i.e., for a chain of hospitality facilities.

In some embodiments, reporting component 740 may aggregate, process, and/or generate reports relating to information and data from the various components of external enterprise system 170. For example, reporting component 740 may generate reports containing revenue associated with individual hospitality facilities, or other financial statements. In some embodiments, reporting component 740 may generate reports based on information contained in central reservation component 700. For example, reporting component 740 may generate a report as to reservations associated with individual hospitality facilities in a given time period.

Also as shown in FIG. 7, property specific system 180 may include a spa component 750, a restaurant component 760, an in-room services component 770, a printing component 780, and an accounting component 790. The various components of property specific system 180 help to provide property specific services to guests staying at the property. For example, spa reservations and services may be processed by spa component 750; and restaurant reservations and services may be processed by restaurant component 760, and in-room service requests may be processed by in-room services component 770. In some embodiments, printing component 780 may be utilized by guests at individual hospitality facility to print documents as needed. In some embodiments, accounting component 790 may perform accounting functions for the various services requested by guests. For example, accounting component 790 may provide up-to-date accounting of guest activities and reconciliation with a guest's folio.

It is contemplated that any of the various components of property specific system 180 may be enabled or disabled by users of system 100. For example, a user of system 100 may disable spa component 750 at a specified time period where spa services may be unavailable to guests at a property. For another example, printing component 780 may be enabled or disabled depending on the room a guest is staying. It is contemplated the enabling and disabling of the various components of property specific system 180 may be set by users of system 100 or may be set according to a predetermined schedule and/or appropriate rule set.

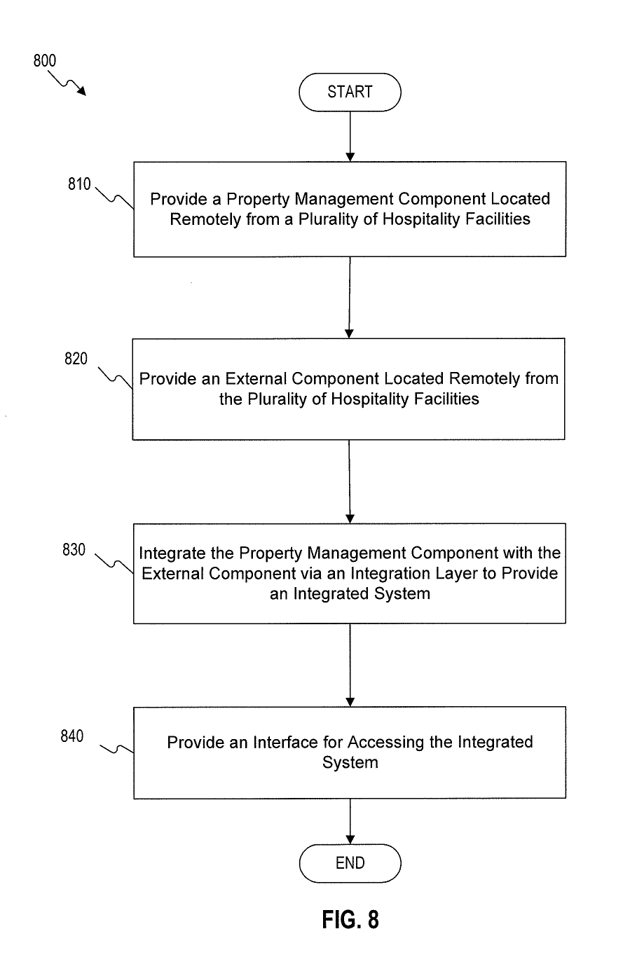

FIG. 8 illustrates an exemplary process 800 for managing a plurality of hospitality facilities. In the embodiment as shown, at stage 810, process 800 provides a property management component located remotely from the plurality of hospitality facilities. In some embodiments, property management component may include one or more components of property management layer 130.

At stage 820, process 800 may provide an external component located remotely from the plurality of hospitality facilities. In some embodiment, the external component may include one or more components from external enterprise systems 170 and/or one or more components from property specific systems 180. It is contemplated that the external component may sub-components in order to provide users of system 100 with the functionalities and capabilities that a typical PMS does not provide.

At stage 830, process 800 may integrate the property management component with the external component via an integration layer to provide an integrated system. In some embodiments, the integrated system may be system 100. In some embodiments, the integrated system may provide hospitality services at the plurality of hospitality facilities. In some embodiments, the hospitality services may include providing guests at individual properties with solutions to their questions, providing recommendations to local attractions, providing in-room services, making reservations for restaurants, spas, shows and special events, arranging transportation or providing directions to various destinations, and providing other services at individual properties as requested by the guests, etc.

At stage 840, process 800 may provide an interface for accessing the integrated system. In some embodiments, the interface may be interface 110. Interface 110 may be located on one of the plurality of hospitality facilities. Users may access system 100 via interface 110. In some embodiments, before using system 100, users' credentials may first be validated with the information provided by role and access component 250. It is contemplated that interface 110 may include the necessary links and/or applets to allow users to utilize the various components and/or applications of system 100.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of managing a plurality of hospitality facilities, comprising:
providing a property management component located remotely from the plurality of hospitality facilities;
providing an external component located remotely from the plurality of hospitality facilities;
integrating the property management component with the external component via an integration layer to provide an integrated system, the integrated system providing hospitality services at the plurality of hospitality facilities; and
providing an interface for accessing the integrated system, the interface being located on one of the plurality of hospitality facilities,
wherein the external component comprises a loyalty component that interacts with the integrated system for providing a user with the ability to access a hospitality service at one of the plurality of hospitality facilities.

2. The method of claim 1, further comprising:
providing an administration and configuration layer located remotely from the plurality of hospitality facilities; and
communicating the administration and configuration layer with the integration layer and the property management component.

3. The method of claim 1, further comprising:
providing a property specific system located remotely from the plurality of hospitality facilities; and
communicating the property specific system with the integration layer, the property specific system providing services at the plurality of hospitality facilities.

4. The method of claim 1, further comprising:
providing a third party integration component located remotely from the plurality of hospitality facilities; and
communicating the third party integration component with the integration layer, the third party integration component allowing access to the integrated system via a mobile device.

5. The method of claim 3, further comprising:
providing a plurality of service components in the property specific system; and
enabling one of the plurality of service components in the property specific system to provide a desired service at the plurality of hospitality facilities.

6. A system for managing a plurality of hospitality facilities, comprising:
a property management component located remotely from the plurality of hospitality facilities;
an external component located remotely from the plurality of hospitality facilities;
an integration layer integrating the external component and the property management component to provide services at the plurality of hospitality facilities; and
an interface for accessing the system, the interface being located on one of the plurality of hospitality facilities,
wherein the external component comprises a loyalty component that interacts with the integrated system for providing a user with the ability to access a service at one of the plurality of hospitality facilities.

7. The system of claim 6, further comprising an administration and configuration layer, in communication with the integration layer and the property management component.

8. The system of claim 6, wherein the external component comprises one of: an external system and a property specific system.

9. The system of claim 8, wherein the external system comprises one of: a central reservation component, a financial component, the loyalty component, a revenue component, and a reporting component.

10. The system of claim 6, wherein the property management component comprises one of: a customization component, a reporting and printing component, a property administration and configuration component, an accounts receivable component, a housekeeping component, a reservations component, a financial management component, a posting component, a room management component, a groups component, a guest services component, and a pricing and inventory management component.

11. The system of claim 6, further comprising a property specific system in communication with the integration layer that provides services at the plurality of hospitality facilities.

12. The system of claim 11, wherein the property specific system includes a plurality of service components that are enabled to provide services at the plurality of hospitality facilities, such that when one of the plurality of service components is disabled, the service component cannot provide its associated service at the plurality of hospitality.

13. The system of 12, wherein the plurality of service components comprises one of: a spa component, a restaurant component, an in-room services component, a printing component, and an accounting component.

14. The system of claim 6, further comprising a third party integration component in communication with the integration layer that allows access to the system via a mobile device.

15. A system for managing a plurality of hospitality facilities, comprising:
a property management component located remotely from the plurality of hospitality facilities;
an external enterprise component located remotely from the plurality of hospitality facilities;
a property specific system located remotely from the plurality of hospitality facilities;
an integration layer integrating the external component and the property specific system with the property management component to provide services at the plurality of hospitality facilities; and
an interface for accessing the system, the interface being located on one of the plurality of hospitality facilities,
wherein the external component comprises a loyalty component that interacts with the integrated system for providing a user with the ability to access a service at one of the plurality of hospitality facilities.

16. The system of claim 15, wherein the property management component comprises one of: a customization component, a reporting and printing component, a property administration and configuration component, an accounts receivable component, a housekeeping component, a reservations component, a financial management component, a posting component, a room management component, a groups component, a guest services component, and a pricing and inventory management component.

17. The system of claim 15, wherein the property specific system includes a plurality of service components that are enabled to provide services at the plurality of hospitality facilities, such that when one of the plurality of service components is disabled, the service component cannot provide its associated service at the plurality of hospitality.

18. The system of 17, wherein one of the plurality of service components is enabled according to a predetermined schedule.

19. The system of 17, wherein the plurality of service components comprises one of: a spa component, a restaurant component, an in-room services component, a printing component, and an accounting component.

20. The system of claim 15, further comprising a third party integration component in communication with the integration layer that allows access to the system via a mobile device.
